(19) United States
(12) Patent Application Publication
(10) Pub. No.: US 2009/0250265 A1
(43) Pub. Date: Oct. 8, 2009

(54) Impact powered transmitter for directional drilling

(76) Inventor: Steven W. Wentworth, Brookfield, WI (US)

Correspondence Address: Philip G. Meyers;Philip G. Meyers Law Office, Suite 300, 1009 Long Prairie Road, Flower Mound, TX, 75022, US

(21) Appl. No.: 12/080,972

(22) Filed: Apr. 8, 2008

(51) Int. Cl. E21B 47/02; E21B 4/14; G01V 3/165; G01V 3/08; E21B 47/12

(52) U.S. Cl. 175/45; 173/114; 324/207.26; 324/326

(57) ABSTRACT

A pneumatic earth boring tool includes a cylindrical body, a transmitter mounted in the body, the transmitter generating a signal usable for operating the earth boring tool, a linear generator mounted in the body for generating an electrical current to power the transmitter and a rectifier for converting the electrical current produced by the linear generator to direct current. Electrical power generated by the linear generator is used to power the transmitter to generate a signal useful for locating the tool.

### TECHNICAL FIELD

The invention relates to pneumatic impact-type tools (moles) that include an onboard sonde for determining the position of the mole during the boring operation.

### BACKGROUND OF THE INVENTION

The use of pneumatic impact-type tools (moles) for horizontal boring is well known. These tools generally include a cylindrical body with a tapered nose, a compressed air supply connection, a piston or striker disposed for reciprocal movement within the tool, and an air distributing mechanism for causing the striker to move rapidly back and forth. The striker reciprocates within the body striking a front interior surface of the tool body, forcing the tool forward into the earth. One such tool is disclosed in U.S. patent application Ser. No. 5,025,868, the disclosure of which is incorporated herein by reference for all purposes.

Pneumatic impact mole users have long sought an easy and effective way of locating a mole during boring operations While precisely locating the mole is not needed in every boring operation, on many occasions it is desirable to know the path, depth or location of the mole. In the past, the operator typically walked over the ground above the bore and based on the observed intensity of the seismic vibrations induced by operation, judged where the mole is located. This method worked with an accuracy of plus/minus two to three feet in a horizontal direction. The method however, did not provide a reliable indication of the depth of the mole.

The desire and need to be able to determine the position of a mole while drilling led to the development of electronic locating devices for use in horizontal underground boring operations. A sensor and transmitting device (“sonde”) is attached to the boring tool to enable the operator to locate the tool. See, for example, Mercer U.S. Pat. Nos. 5,155,442 and 5,633,589. Prior art sondes located in the body of a mole included a transmitter and rechargeable batteries, formerly available from Radio Detection Corp. The sonde is typically mounted in a pocket of the steel front anvil which projects forward from the body of the mole. The pocket is closed with a plastic door that traps the sonde in the pocket and is transparent with respect to the emission of a signal from the transmitter. The signal from the sonde is detected and analyzed with a walk-over receiver well known in the art of Horizontal Directional Drilling (HDD).

One weakness or drawback of designs including a sonde enclosed in the tool body is the need to remove and recharge the battery powering the sonde. Failure to consistently recharge the battery results in a weakened or discharged battery leaving the sonde incapable of transmitting a signal. However, since not every boring operation requires the use of a sonde, the probability of the sonde being charged on a consistent basis is low. Consequently, the sonde is often inoperable when needed to provide information on the depth or location of a mole.

A third method, readily available but infrequently used, is to attach the sonde to the air supply hose of a mole. Again, forethought is required and the sizable projection created by the sonde and its housing impedes operating the mole in the reverse direction. The bulbous projection of the sonde and housing makes it difficult to rotate the air supply hose to shift the tool into the reverse direction. Even when the mole is successfully reversed, the projection impedes rearward progress, often causing the mole to back over the supply hose, requiring excavation of the mole.

### SUMMARY OF THE INVENTION

The invention provides pneumatic earth boring tool with a self-contained sonde module which eliminates the need to remove the sonde from the tool house for recharging. The sonde module includes a transmitter and requires a transmission window through a medium transparent to radio signals. In accordance with the invention, the transmitter is powered by a linear generator incorporated into the module that includes a permanent magnet or magnets that reciprocate along the axis of the mole, either as a result of impact and/or by cycling pneumatic forces. The magnets traverse the length of a wound wire coil inducing a current in the coil. The electrical energy produced in this manner is used to charge an electrical storage device such as a battery or condenser and power the transmitter.

In one aspect, a pneumatic earth boring tool according to the invention includes an elongate body having a nose and a striker disposed for reciprocation in the housing. Compressed air supplied through an air supply connection reciprocates the striker to drive the tool through the earth. A sonde housing, including a magnet tube is mounted in an axially extending cavity formed in the nose for slidably retaining a permanent magnet. A coil surrounds the tube such that an electrical current is generated when the magnet slides through the coil. Elastomeric repulsing elements such as rubber cushions or coil springs are positioned at each end of the tube to repulse the magnet when it strikes the element during operation. A rectifier transforms the alternating current generated when the magnet slides through the coil to produce direct current which is used to power a transmitter that generates a signal useable for locating the tool in the earth.

An energy storage device such as a capacitor and/or battery may be provided to store electrical energy generated by the magnet and coil during operation of the tool. In one variation, the sonde housing is formed from a plastic material and one or more of the coil, transmitter, rectifier and energy storage device may be imbedded in the plastic material. The sonde housing is sealed with an end cap and may be glued or otherwise secured in the axially extending cavity.

### BRIEF DESCRIPTION OF THE DRAWINGS

FIG. 1 is a partial perspective view of a pneumatic earth boring tool incorporating a sonde module of the invention;

FIG. 2 is a partial perspective view of the nose section of the tool of FIG. 1;

FIG. 3 is side view of the nose section of the tool of FIG. 1;

FIG. 4 is a front view of the nose section of the tool of FIG. 1;

FIG. 5 is a top view of the nose section of the tool of FIG. 1;

FIG. 6, is an end view of the nose section of the tool of FIG. 1; and

FIG. 7 is a partial lengthwise section of the nose section of the tool of FIG. 1 taken along line A-A of FIG. 5.

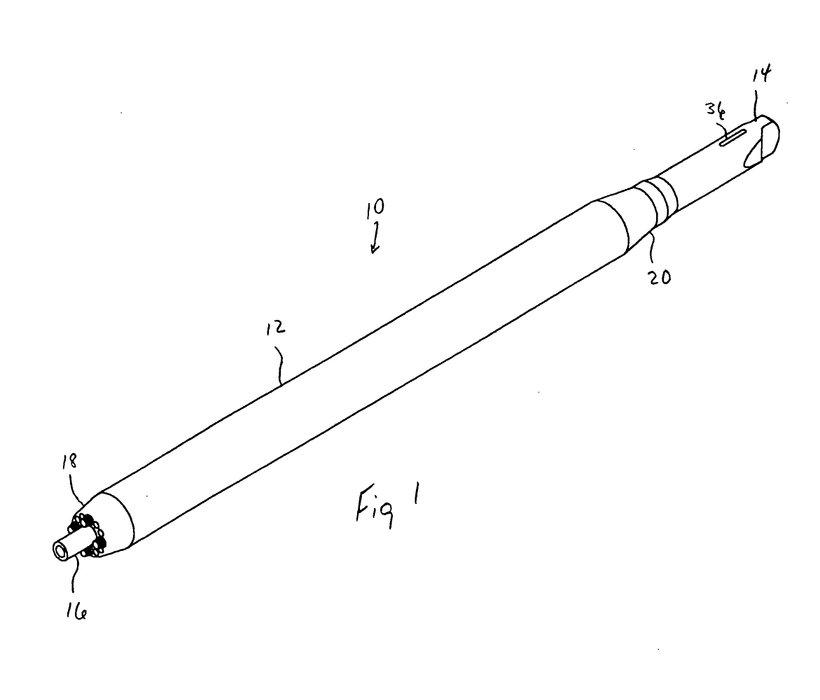

### DETAILED DESCRIPTION

Referring now to the Figures, a pneumatic earth boring tool 10 in accordance with the invention includes a cylindrical housing 12 having a nose 14, a compressed air supply connection 16 at the rear end 18 of the housing and a frontwardly tapered shoulder 20 extending rearwardly from nose 14. A striker is mounted in housing 12 along with an air distribution system configured to reciprocate the striker back and forth in the housing to force the tool forward through the earth during boring operations. Preferably, the air distribution system of tool 12 is configured to allow the tool to be operated in both forward and reverse modes such as disclosed in commonly assigned U.S. Pat. Nos. 6,953,095 issued Oct. 11, 2005 to Randa and 5,505,270 issued Apr. 9, 1996 to Wentworth, the contents of which are incorporated by reference for all purposes.

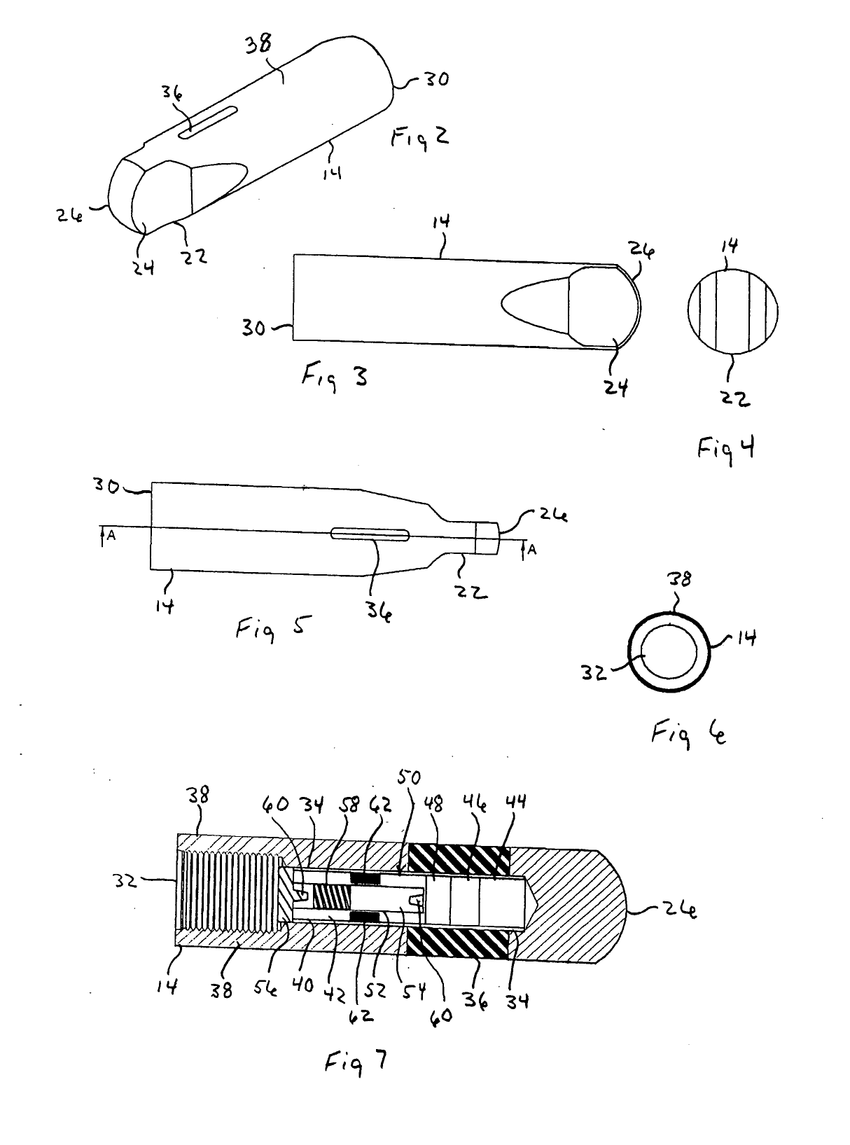

Turning to FIGS. 2-7, nose 14 includes a forward end section 22 with flat sidewalls 24, a curved tip 26 and a rear end 30. A rearwardly opening threaded socket 32 is formed in rear end 30 for attaching nose 14 to housing 12. A cylindrical, axially extending sonde cavity 34 extends forward from socket 32 along the central axis of nose 14. Since nose 14 is typically made of steel, a pair of opposed transmission windows or slots 36 are formed through a sidewall 38 of the nose 14 so that a radiofrequency signal generated by a sonde positioned in sonde cavity 34 can be detected a walk-over or similar receiver. As illustrated, slots 36 may be filled with a plastic or a potting material to seal cavity 34 while simultaneously allowing a radio frequency signal to be transmitted through housing 12. Although as shown, two radially opposed slots 36 are formed in nose 14, a single slot or a plurality of slots at different radial positions may be employed.

As best illustrated in FIG. 7, a sonde module 40 including a sonde housing 42, wireless transmitter 44, power storage unit 46, rectifier 48 and linear generator 50 is positioned in cavity 34. Linear generators are known power sources that utilize a stator and/or rotor traveling in a linear path to produce electric power. See, e.g., U.S. Pat. No. 5,975,714 issued Nov. 2, 1999 to Vetorino et al., the disclosure of which is incorporated herein by reference for all purposes. Housing 42 is preferably formed from a hard, nonmetal material such as an appropriate plastic and includes a magnet tube 52 made of plastic or non-electrically conductive metal having a central passage 54. In one embodiment, sonde housing 42 is glued into position in sonde cavity 34 of nose 14 and closed with an end cap 56 that is glued or otherwise fastened in position to seal housing 42.

One or more permanent magnets 58 are slidably disposed in tube 52 such that the magnet slides in an axially direction back and forth in passage 54 when tool 10 moves in response to reciprocation of the striker. A magnet travel stop 60 is positioned at each end of tube 52 to prevent damage to housing 42 and/or magnet 58 when the magnet collides with the end of the tube. Magnet travel stops 60 are preferably formed from an elastomeric material such as a natural or synthetic rubber, but may also include a spring or a fixed magnet oriented such that the polarity of the fixed magnet opposes that of the sliding magnet 58.

A coil 62, typically copper wire, is wound around passage 54 such that magnet 58 passes thorough the coil as it slides through tube 50, generating an alternating electric current. In one embodiment, coil 60 is imbedded in sonde housing 42 by potting or during injection molding in the manufacturing process. One of more of transmitter 44, power storage unit 46 and rectifier 48 may also be embedded in the housing material in the same manner to protect the electronic components from shock during operation of the tool as well as sealing the components against contamination.

The current produced by magnet 58 passing through coil 60 is conducted to rectifier 48 which converts the alternating current to direct current used to power transmitter 44 and/or charge power storage unit 46. Power storage unit 46 may be a battery, a capacitor or both. In one embodiment, power storage unit 46 is omitted and power is supplied directly from rectifier 48 to transmitter 44.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

1. A pneumatic earth boring tool comprising:
a cylindrical body;
a transmitter mounted in the body, the transmitter generating a signal usable for operating the earth boring tool;
a linear generator mounted in the body for generating an electrical current to power the transmitter; and
a rectifier for converting the electrical current produced by the linear generator to direct current; and
electrical connections connecting the transmitter to the electrical current.

2. The tool of claim 1 further comprising an energy storage device for storing energy generated by the linear generator.

3. The tool of claim 2 wherein the energy storage device comprises a capacitor.

4. The tool of claim 2 wherein the energy storage device comprises a battery.

5. The tool of claim 1 wherein the linear generator comprises a magnet and a coil and wherein one of the magnet and coil is movable relative to the other.

6. The tool of claim 1 wherein the linear generator comprises a tube, a permanent magnet disposed for reciprocating movement in the tube, a coil disposed around the circumference of the tube and at least one repulsing element that repulses the magnet as it reciprocates in the barrel.

7. The tool of claim 6 wherein the repulsing element is one of a spring, a magnet and an elastomeric material.

8. The tool of claim 1 wherein the tool further comprises a cylindrical housing having a cavity for receiving a sonde and wherein the wireless transmitter and linear generator are mounted in the cavity.

9. An underground earth boring tool comprising:
an elongated body including a nose and an air supply connection for supplying compressed air to a striker disposed in the body to reciprocate the striker and cause the elongated body to move through the earth, the body including a cavity for receiving a transmitter;
a transmitter mounted in the cavity for transmitting a signal indicating the location of the tool when the tool is in operation;
a linear generator mounted in the cavity, the generator converting motion of the tool into electrical current;
a rectifier for converting the electrical current generated by the linear generator to direct current to provide power for the transmitter; and
electrical connections connecting the transmitter to the electrical current.

10. The tool of claim 9 further comprising a sonde housing and wherein the transmitter and linear generator are mounted in the sonde housing and wherein the sonde housing is glued in place in the cavity.

11. The tool of claim 9 further comprising one of a battery or capacitor for storing energy produced by the linear generator.

12. The tool of claim 10 wherein the sonde housing further comprises a magnet tube and wherein the linear generator comprises a permanent magnet slidably disposed in the magnet tube; and
A coil positioned around the magnet tube such that movement of the tool causes the magnet to slide through the coil, generating an electric current.

13. The tool of claim 12 wherein the sonde housing is formed from a plastic material and the coil is imbedded in the housing.

14. The tool of claim 11 further comprising a repulsing element mounted adjacent each end of the tube for repulsing the magnet as it reciprocates in the tube.

15. An earth boring tool comprising:
An elongate body having a nose including an axially extending sonde cavity formed in the nose;
a sonde housing mounted in the axially extending sonde cavity, the sonde housing including a magnet tube for slidably retaining a permanent;
a permanent magnet retained in the magnet tube, the magnet sliding in the tube during operation of the tool;
an elastomeric magnet repulsing element mounted at each end of the magnet tube for repulsing the magnet when the magnet strikes the element;
a coil mounted in the sonde housing, the coil generating an electric current when the magnet passes therethrough;
a rectifier mounted in the sonde housing, the rectifier transforming alternating current produced by movement of the magnet through the coil into direct current;
a transmitter powered by electric energy generated by the magnet and coil, the transmitter generating a signal usable to locate the tool during operation; and
electrical connections connecting the transmitter to the electric current.

16. The tool of claim 15 further comprising a striker disposed for reciprocation in the housing and an air supply connection for supplying compress air to reciprocate the striker to drive the tool through the earth.

17. The tool of claim 16 further comprising one or both of a battery and capacitor for storing electrical energy generated by the magnet and coil.

18. The tool of claim 17 further comprising slots formed in the nose of the tool, the slots enabling transmission of a radio frequency signal from the transmitter to the surface of the earth.

19. The tool of claim 17 wherein the sonde housing is formed from a plastic material and wherein the coil and transmitter are embedded in the plastic material.

20. The tool of claim 17 wherein the transmitter is a wireless radio frequency transmitter.
